(19) United States
(12) Patent Application Publication
(10) Pub. No.: US 2025/0118828 A1
(43) Pub. Date: Apr. 10, 2025

(54) BATTERY MODULE COOLING STRUCTURE

(71) Applicants: HYUNDAI MOTOR COMPANY, SEOUL (KR); KIA CORPORATION, SEOUL (KR)

(72) Inventors: Hyunchang Kang, Hwaseong-si (KR); Jiwoong Jung, Hwaseong-si (KR); Junyoung Kang, Hwaseong-si (KR)

(73) Assignees: HYUNDAI MOTOR COMPANY, SEOUL (KR); KIA CORPORATION, SEOUL (KR)

(21) Appl. No.: 18/910,752

(22) Filed: Oct. 9, 2024

(30) Foreign Application Priority Data
Oct. 10, 2023 (KR) 10-2023-0134349

(51) Int. Cl. H01M 10/6567; H01M 10/613; H01M 10/625; H01M 10/647; H01M 50/211; H01M 50/242; H01M 50/289

(52) U.S. Cl. CPC H01M 10/6567; H01M 10/613; H01M 10/625; H01M 10/647; H01M 50/211; H01M 50/242; H01M 50/289; H01M 2220/20

(57) ABSTRACT

A battery module cooling structure for a battery module is configured by assembling a plurality of battery cells, the battery module cooling structure including a battery module housing configured to accommodate therein the battery module, and cooling channels provided in the battery module housing, disposed between the plurality of battery cells, and configured to support the plurality of battery cells, the cooling channels being configured to guide a cooling liquid introduced into the battery module housing so that the cooling liquid flows between the plurality of battery cells in one direction of the battery cell.

### CROSS REFERENCE TO RELATED APPLICATIONS

This application claims priority to and the benefit of Korean Patent Application No. 10-2023-0134349 filed in the Korean Intellectual Property Office on Oct. 10, 2023, the entire contents of which are incorporated herein by reference.

### BACKGROUND

### (a) Field

The present disclosure relates to a battery module cooling structure, and more particularly, to a cooling structure for an immersion cooling battery module, in which cooling channels are provided between battery cells to allow a cooling liquid to flow in the battery module.

### (b) Description of the Related Art

In general, a battery pack for an environmentally friendly vehicle includes battery modules made by assembling a plurality of battery cells. The final battery pack mounted in the vehicle is manufactured by assembling a plurality of battery modules.

A pouch cell-based battery module broadly includes battery cells, surface pressure pads, endplates, sensing boards, and the like. The battery module requires advanced battery cell cooling technologies to meet the high specifications related to the high performance and fast charging performance of batteries. An immersion cooling technology, which is a direct cooling technology, may be considered to improve the cooling performance. The components used for the immersion cooling method include basic components of the battery module, a module housing, a cooling channel, and a cooling liquid (dielectric thermal fluid) for direct cooling.

In this case, in order to cool inner battery cells, cooling channels may be disposed between the battery cells, and direct cooling may be implemented by a flow of the cooling liquid. In the case of a general battery cell module, a sensing board is provided on a flow path through which the cooling liquid is introduced or discharged, and the presence of the sensing board hinders the flow of cooling liquid through the cooling channel between the battery cells, which may degrade the cooling efficiency.

### SUMMARY

The present disclosure attempts to provide a battery module cooling structure having cooling channels configured to allow a cooling liquid to flow between battery cells of a battery module, such that the cooling liquid smoothly flows in the battery module, which may improve cooling performance efficiency and structural stability.

An embodiment of the present disclosure provides a battery module cooling structure for a battery module, which is configured by assembling a plurality of battery cells, the battery module cooling structure including a battery module housing configured to accommodate therein the battery module, and cooling channels provided in the battery module housing, disposed between the plurality of battery cells, and configured to support the plurality of battery cells, the cooling channels being configured to guide a cooling liquid introduced into the battery module housing so that the cooling liquid flows between the plurality of battery cells in one direction of the battery cell.

An inlet port, through which the cooling liquid is introduced into the battery module housing, may be provided at one side of the battery module housing, and an outlet port, through which the cooling liquid is discharged to the outside of the battery module housing, may be provided at the other side of the battery module housing.

A surface pressure pad configured to absorb a swell of the battery cell may be attached between the battery cells, and an endplate may be attached to an outer side of the cooling channel positioned at an outermost periphery of the battery module.

The cooling channel may include horizontal cooling channels respectively coupled to two opposite ends of the surface pressure pad between the battery cells and extending in a longitudinal direction of the battery cell, and a vertical cooling channel coupled to the horizontal cooling channels, attached to one side surface of the battery cell, and extending in the longitudinal direction of the battery cell.

A plurality of cooling liquid passageways may be formed in the cooling channel and extend in the longitudinal direction of the battery cell.

A cross-section of the vertical cooling channel may be coupled to one edge surface of the horizontal cooling channel.

A cross-section of the vertical cooling channel may be coupled to a central surface of the horizontal cooling channel.

The horizontal cooling channel may include a coupling protrusion having one end extending in the longitudinal direction of the battery cell and protruding in a stacking direction of the battery cells, and a coupling groove having the other end extending in the longitudinal direction of the battery cell, recessed in the stacking direction of the battery cells, and fastened to the protrusion of the adjacent horizontal cooling channel.

The coupling protrusion may have a shape in which a central portion of an end of the horizontal cooling channel protrudes, and the coupling groove may have a shape recessed to correspond to the shape of the coupling protrusion.

The coupling protrusion may have a shape protruding in a hemispherical shape, and the coupling groove may have a shape recessed to correspond to the shape of the coupling protrusion.

The coupling protrusion may have a shape in which one side of an end of the horizontal cooling channel protrudes, and the coupling groove may have a shape recessed to correspond to the shape of the coupling protrusion.

According to the embodiment of the present disclosure, the cooling channels are provided to allow the cooling liquid to flow between the battery cells of the battery module, such that the cooling liquid may be introduced, flow, and be discharged along the optimal route between the battery cells, thereby maximizing the cooling performance efficiency.

In addition, the cooling channels coupled to the surface pressure pads are provided between the battery cells, such that structural stability may be ensured, and surface pressure may be applied when the battery cell swells, which may contribute to ensuring the performance of the battery cell.

### BRIEF DESCRIPTION OF THE FIGURES

FIG. 1 is a perspective view illustrating a battery module cooling structure according to an embodiment of the present disclosure.

FIG. 2 is an exploded perspective view illustrating an interior of the battery module cooling structure according to the embodiment of the present disclosure.

FIG. 3A is a cross-sectional view illustrating a coupling relationship between cooling channels of the battery module cooling structure according to the embodiment of the present disclosure.

FIG. 3B is a cross-sectional view illustrating a state in which the cooling channels of the battery module cooling structure according to the embodiment of the present disclosure are coupled.

FIG. 4 is a cross-sectional view illustrating an example of the cooling channel of the battery module cooling structure according to the embodiment of the present disclosure.

FIG. 5 is a cross-sectional view illustrating another example of the cooling channel of the battery module cooling structure according to the embodiment of the present disclosure.

FIGS. 6A, 6B, and 6C are views illustrating various examples in which horizontal cooling channels of the battery module cooling structure according to the embodiment of the present disclosure are coupled.

### DETAILED DESCRIPTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways and is not limited to the embodiments described herein.

In addition, the constituent elements having the same configurations in several embodiments will be assigned with the same reference numerals and described only in the representative embodiment, and only the constituent elements, which are different from the constituent elements according to the representative embodiment, will be described in other embodiments.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. Further, the same reference numerals designate the same structures, elements or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiment of the present disclosure specifically illustrates an example of the present disclosure. As a result, various modifications of the drawings are expected. Therefore, the embodiments are not limited to specific forms in regions illustrated in the drawings, and for example, include modifications of forms by the manufacture thereof.

Hereinafter, a battery module cooling structure according to an embodiment of the present disclosure will be described in detail with reference to the accompanying drawings.

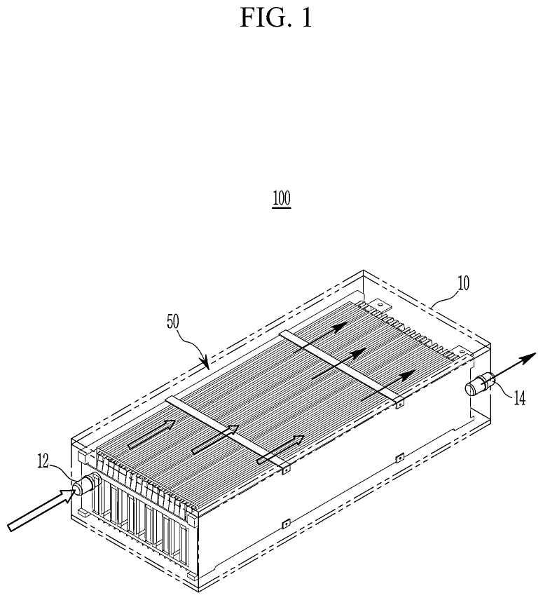

FIG. 1 is a perspective view illustrating a battery module cooling structure according to an embodiment of the present disclosure.

With reference to FIG. 1, a battery module cooling structure 100 according to an embodiment of the present disclosure includes a battery module housing 10 configured to accommodate therein a battery module 50, and cooling channels 30 disposed in the battery module housing 10.

The cooling channels 30 may be disposed between the plurality of battery cells 20 of the battery module 50 and support the plurality of battery cells 20. In addition, the cooling channels may serve to guide a cooling liquid, which is introduced into the battery module housing 10, so that the cooling liquid flows between the plurality of battery cells 20 in one direction of the battery cell 20.

An inlet port 12, through which the cooling liquid is introduced into the battery module housing 10, may be provided at one side of the battery module housing 10, and an outlet port 14, through which the cooling liquid is discharged to the outside from an interior of the battery module housing 10, may be provided at the other side opposite to one side of the battery module housing 10.

The inlet port 12 and the outlet port 14 communicate with the interior of the battery module housing 10. In addition, the inlet port 12 and the outlet port 14 may be different in horizontal positions and forward and rearward positions so that the cooling liquid evenly flows in the battery module housing 10. That is, as illustrated in FIG. 1, the inlet port 12 may be positioned at a position higher than the outlet port 14, and the inlet port 12 may be positioned rearward of the outlet port 14.

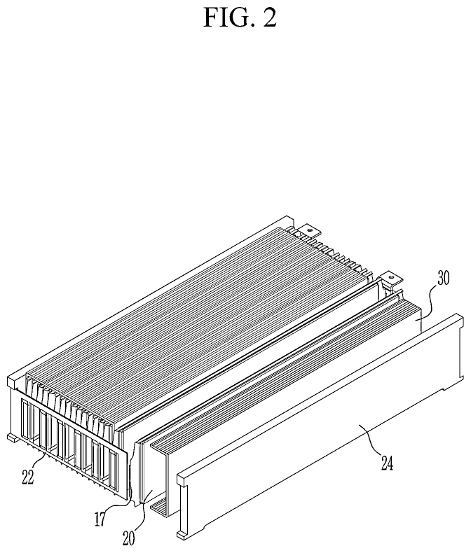

FIG. 2 is an exploded perspective view illustrating the interior of the battery module cooling structure according to the embodiment of the present disclosure.

With reference to FIG. 2, surface pressure pads 17 configured to absorb a swell of the battery cells 20 may be attached between the plurality of battery cells 20 of the battery module 50. The surface pressure pads 17 may fix the plurality of battery cells 20 and mitigate an impact applied to the battery cells 20. Endplates 24 may be attached to outer sides of the cooling channels 30 positioned at outermost peripheries of the battery module 50. In addition, a sensing board 22 may be fastened to one end of each of the endplates 24 attached at the two opposite sides.

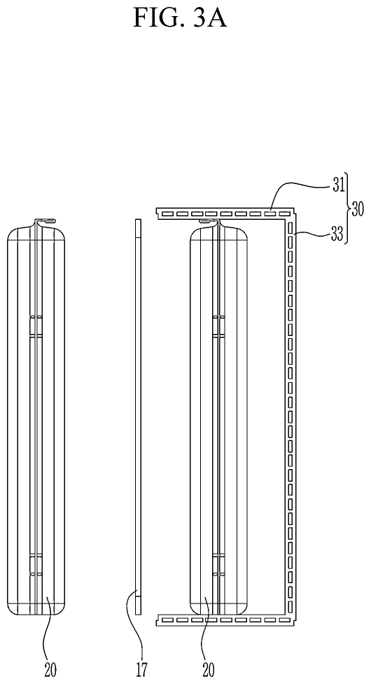

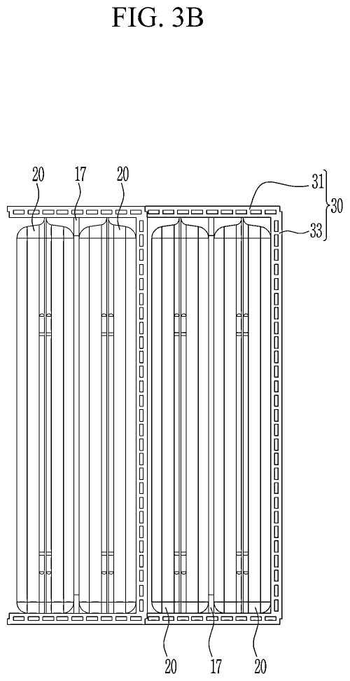

FIG. 3A is a cross-sectional view illustrating a coupling relationship between the cooling channels of the battery module cooling structure according to the embodiment of the present disclosure, and FIG. 3B is a cross-sectional view illustrating a state in which the cooling channels of the battery module cooling structure according to the embodiment of the present disclosure are coupled.

With reference to FIGS. 3A and 3B, the cooling channel 30 may be provided to surround the two adjacent battery cells 20. The cooling channel 30 may include two upper and lower horizontal cooling channels 31, and a vertical cooling channel 33 configured to connect the horizontal cooling channels 31.

The horizontal cooling channel 31 may have a rectangular plate shape extending in a longitudinal direction of the plurality of battery cells 20 and extending in a stacking direction of the plurality of battery cells 20. Upper and lower ends of the battery cells 20 may be coupled to the horizontal cooling channels 31, and upper and lower ends of the surface pressure pads 17 may be coupled to the horizontal cooling channels 31.

In addition, the vertical cooling channel 33 may be coupled to one end of each of the upper and lower horizontal cooling channels 31 and attached to one side surface of the battery cell 20. The vertical cooling channel 33 may be attached to one surface of the battery cell by a bonding agent such as hot-melt adhesive. The vertical cooling channel 33 may have a rectangular plate shape extending in the longitudinal direction of the plurality of battery cells 20.

As illustrated in FIG. 3B, upper and lower portions of the surface pressure pad 17 may be coupled to inner central portions of the horizontal cooling channels 31. The two battery cells 20 and the single surface pressure pad 17 may be disposed in a ‘⊏’-shaped unit defined by the two upper and lower horizontal cooling channels 31 and the single vertical cooling channel 33. In addition, the adjacent horizontal cooling channels 31 are connected to each other and surround the outer periphery of the battery module 50, and the vertical cooling channel 33 is interposed between the battery cells 20.

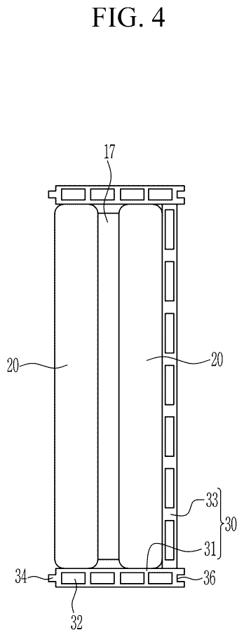

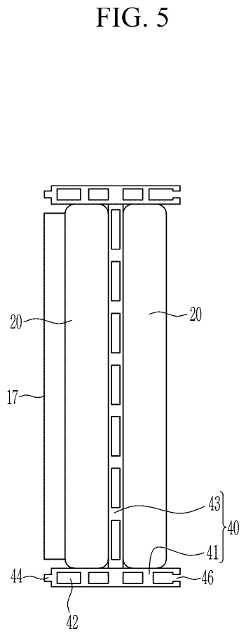

FIG. 4 is a cross-sectional view illustrating an example of the cooling channel of the battery module cooling structure according to the embodiment of the present disclosure, and FIG. 5 is a cross-sectional view illustrating another example of the cooling channel of the battery module cooling structure according to the embodiment of the present disclosure.

As illustrated in FIGS. 4 and 5, a plurality of cooling liquid passageways 32 or 42 extending in the longitudinal direction of the battery cell 20 may be respectively formed in the horizontal cooling channel 31 or 41 and the vertical cooling channel 33 or 43. The cooling liquid passageway 32 or 42 communicates with an internal space of the battery module housing 10 outside the battery module 50. The cooling liquid introduced into the battery module housing 10 through the inlet port 12 is introduced into the cooling liquid passageways 32 or 42 and cools the battery cells 20 while flowing in the longitudinal direction of the battery cells 20. The cooling liquid having passed through the cooling liquid passageways 32 or 42 is discharged to the outside from the battery module housing 10 through the outlet port 14. The plurality of cooling liquid passageways 32 or 42 may be spaced apart from one another at predetermined intervals and each have a rectangular cross-sectional shape.

As illustrated in FIG. 4, the cooling channel 30 may have a structure in which a cross-section of the vertical cooling channel 33 is coupled to one edge surface of the horizontal cooling channel 31. That is, the cooling channel 30 may be shaped to surround the two battery cells 20 and the surface pressure pad 17 disposed between the two battery cells 20.

In addition, as illustrated in FIG. 5, the cooling channel 40 may have a structure in which a cross-section of the vertical cooling channel 43 is coupled to a central surface of the horizontal cooling channel 41. That is, the cooling channel 40 may have a ‘I’ shape, one battery cell 20 may be disposed at one side of the vertical cooling channel 43, and another battery cell 20 and the surface pressure pad 17 are disposed at the other side of the vertical cooling channel 43.

Meanwhile, the horizontal cooling channels 31 or 41 may be connected to each other by coupling a coupling protrusion 34 and a coupling groove 36. The coupling protrusion 34 is formed at one end of the horizontal cooling channel 31 or 41, and the coupling groove 36 is formed at the other end of the horizontal cooling channel 31 or 41. The coupling protrusion 34 may extend in the longitudinal direction of the battery cell 20 and protrude in the stacking direction of the plurality of battery cells 20. In addition, the coupling groove 36 may have a shape extending in the longitudinal direction of the battery cell 20 and recessed in the stacking direction of the plurality of battery cells 20. The coupling groove 36 may be coupled to the coupling protrusion 34 formed on the adjacent horizontal cooling channel 31 or 41 by male-female coupling.

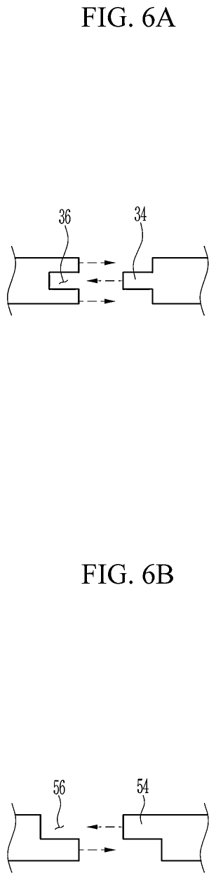

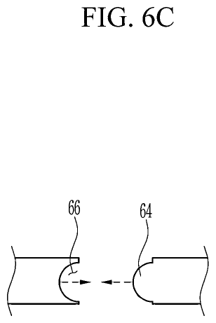

FIGS. 6A-6C are views illustrating various examples in which horizontal cooling channels of the battery module cooling structure according to the embodiment of the present disclosure are coupled.

As illustrated in FIG. 6A, the coupling protrusion 34 may have a shape in which a central portion of an end of the horizontal cooling channel 31 or 41 protrudes, and the coupling groove 36 may have a shape recessed to correspond to the shape of the coupling protrusion 34. That is, the coupling groove 36 and the coupling protrusion 34 may define concave and convex portions and be fastened to each other.

In addition, as illustrated in FIG. 6B, a coupling protrusion 54 may have a shape in which one side of an end of the horizontal cooling channel 31 or 41 protrudes, and a coupling groove 56 may have a shape recessed to correspond to the shape of the coupling protrusion 54. That is, the coupling protrusion 54 and the coupling groove 56 may have symmetrically stepped shape and be fastened to each other.

In addition, as illustrated in FIG. 6C, a coupling protrusion 64 may have a shape protruding in a hemispherical shape, and a coupling groove 66 may have a shape recessed to correspond to the shape of the coupling protrusion 64, such that the coupling protrusion 64 and the coupling groove 66 may be fastened to each other.

As described above, according to the embodiment of the present disclosure, the cooling channels are provided to allow the cooling liquid to flow between the battery cells of the battery module, such that the cooling liquid may be introduced, flow, and be discharged along the optimal route between the battery cells, thereby maximizing the cooling performance efficiency.

In addition, the cooling channels coupled to the surface pressure pads are provided between the battery cells, such that structural stability may be ensured, and surface pressure may be applied when the battery cell swells, which may contribute to ensuring the performance of the battery cell.

While the exemplary embodiments of the present disclosure have been described, the present disclosure is not limited to the embodiments. The present disclosure covers all modifications that can be easily made from the embodiments of the present disclosure by those skilled in the art and considered as being equivalent to the present disclosure.

1. A battery module cooling structure for a battery module, which is configured by assembling a plurality of battery cells, the battery module cooling structure comprising:
a battery module positioned within a battery module housing; and
a plurality of cooling channels positioned in the battery module housing, disposed between the plurality of battery cells, and configured to support the plurality of battery cells, the plurality of cooling channels being configured to guide a cooling liquid introduced into the battery module housing so that the cooling liquid flows between the plurality of battery cells in one direction of the plurality of battery cells.

2. The battery module cooling structure of claim 1, wherein:
an inlet port, through which the cooling liquid is introduced into the battery module housing, is positioned at one side of the battery module housing; and
an outlet port, through which the cooling liquid is discharged to an outside of the battery module housing, is positioned at an other side of the battery module housing.

3. The battery module cooling structure of claim 1, wherein:
a surface pressure pad configured to absorb a swell of the battery cell is attached between the plurality of battery cells; and
an endplate is attached to an outer side of the cooling channel positioned at an outermost periphery of the battery module.

4. The battery module cooling structure of claim 3, wherein:
the plurality of cooling channels comprise:
a plurality of horizontal cooling channels coupled to two opposite ends of the surface pressure pad between the battery cells and extending in a longitudinal direction of the battery cell; and
a plurality of vertical cooling channels coupled to the horizontal cooling channels, and attached to one side surface of the battery cell, and extending in the longitudinal direction of the battery cell.

5. The battery module cooling structure of claim 4, wherein:
a plurality of cooling liquid passageways are formed in each of the plurality of cooling channels, and extend in the longitudinal direction of the battery cell.

6. The battery module cooling structure of claim 5, wherein:
a cross-section of each of the vertical cooling channels is coupled to one edge surface of each of the horizontal cooling channels.

7. The battery module cooling structure of claim 5, wherein:
a cross-section of each of the vertical cooling channels is coupled to a central surface of each of the horizontal cooling channels.

8. The battery module cooling structure of claim 4, wherein:
each of the horizontal cooling channels comprise:
a coupling protrusion having one end extending in the longitudinal direction of the battery cells and protruding in a stacking direction of the battery cells; and
a coupling groove having an other end extending in the longitudinal direction of the battery cells, recessed in the stacking direction of the battery cells, and fastened to the protrusion of the adjacent horizontal cooling channel.

9. The battery module cooling structure of claim 8, wherein:
each coupling protrusion has a shape in which a central portion of an end of each of the horizontal cooling channels protrudes, and each coupling groove has a recessed shape recessed corresponding to the shape of each coupling protrusion.

10. The battery module cooling structure of claim 8, wherein:
each coupling protrusion has a shape protruding in a hemispherical shape, and each coupling groove has a recessed shape corresponding to the shape of each coupling protrusion.

11. The battery module cooling structure of claim 8, wherein:
each coupling protrusion has a shape in which one side of an end of each of the horizontal cooling channels protrudes, and each coupling groove has a recessed shape corresponding to the shape of each coupling protrusion.
